(19) United States
(12) Patent Application Publication
(10) Pub. No.: US 2025/0236535 A1
(43) Pub. Date: Jul. 24, 2025

(54) A METAL OXIDE PRODUCT FOR MANUFACTURING A POSITIVE ELECTRODE ACTIVE MATERIAL FOR LITHIUM-ION RECHARGEABLE BATTERIES

(71) Applicant: Umicore, Brussels (BE)

(72) Inventors: Daniël NELIS, Olen (BE); Kasper LAMBRIGHS, Olen (BE); Randy DE PALMA, Brussels (BE); Liang ZHU, Brussels (BE); Jong-Won SHIN, Neuwied (DE)

(21) Appl. No.: 18/703,479

(22) PCT Filed: Oct. 20, 2022
(86) PCT No.: PCT/EP2022/079270

§ 371 Date: Apr. 22, 2024

(30) Foreign Application Priority Data
Oct. 25, 2021 (EP) 21204484.6

(51) Int. Cl. C01G 53/44; H01M 4/525

(52) U.S. Cl. CPC C01G 53/44; C01P 2002/50; C01P 2004/03; C01P 2004/32; C01P 2004/50; C01P 2004/51; C01P 2004/61; C01P 2004/62; C01P 2004/64; C01P 2006/11; C01P 2006/40; H01M 4/525

(57) ABSTRACT

A metal oxide product for manufacturing a positive electrode active material for lithium-ion rechargeable batteries comprises one or more oxides of one or more metals M′, wherein M′ comprises:
Ni in a content x between 20.0 mol % and 100.0 mol %, relative to M′,
Co in a content y between 0.0 mol % and 60.0 mol %, relative to M′,
Mn in a content z between 0.0 mol % and 80.0 mol %, relative to M′,
D in a content a between 0.0 mol % and 5.0 mol %, relative to the total atomic content of M′, wherein D comprises at least one element of the group consisting of: Al, B, Ba, Ca, Cr, Fe, Mg, Mo, Nb, S, Si, Sr, Ti, Y, V, W, Zn, and Zr,
   wherein x+y+z+a=100.0 mol %,
   wherein the metal oxide product comprises secondary particles each comprising a plurality of primary particles.

### TECHNICAL FIELD AND BACKGROUND

This invention relates to a metal oxide product which is applicable as for manufacturing a positive electrode active material for lithium-ion rechargeable batteries. In particular the invention concerns a nickel-based transition metal oxide which is applicable as a precursor of positive electrode active materials.

In the manufacture of such positive electrode active materials, precursors such as hydroxides, carbonates or oxides containing the desired transition metal elements are usually mixed with a Li-source and then subjected to a thermal treatment to affect a solid state reaction leading to a lithiated transition metal oxide.

Very fine nickel-based transition metal oxide comprising primary particles with average size of 0.4 μm is known from US2010196761. However, the properties of the precursor affect the properties of the final positive electrode active material prepared from them. The metal oxide comprising primary particles from US2010196761 for instance has a low first discharge capacity DQ1 and high capacity fading QF. A high DQ1 and QF are important for the use of positive electrode active material in rechargeable lithium-ion batteries suitable for (hybrid) electrical vehicle applications.

It is an object of the present invention to provide a metal oxide product for manufacturing a positive electrode active material which allows the manufacture of positive electrode active materials having an improved first discharge capacity and capacity fading.

### SUMMARY OF THE INVENTION

The objective of this invention is achieved by a metal oxide product for manufacturing a positive electrode active material for lithium-ion rechargeable batteries, wherein the metal oxide product comprises one or more oxides of one or more metals M′, wherein M′ comprises:
Ni in a content x between 20.0 mol % and 100.0 mol %, relative to M′,
Co in a content y between 0.0 mol % and 60.0 mol %, relative to M′,
Mn in a content z between 0.0 mol % and 80.0 mol %, relative to M′,
D in a content a between 0.0 mol % and 5.0 mol %, relative to the total atomic content of M′, wherein D comprises at least one element of the group consisting of: Al, B, Ba, Ca, Cr, Fe, Mg, Mo, Nb, S, Si, Sr, Ti, Y, V, W, Zn, and Zr,
   wherein x, y, z, and a are measured by ICP, wherein x+y+z+a=100.0 mol %,
   wherein the metal oxide product comprises secondary particles each comprising a plurality of primary particles,
   wherein said primary particles have a first particle size distribution, wherein said first particle size distribution has a first D50 of at most 0.10 μm and a first D99 of at most 0.30 μm.

The first particle size distribution is in this case determined by cross-section SEM image analysis. The first particle size distribution is determined as a cumulative particle size distribution. This can be done in an automated fashion by image analysis software, but also manually. In order to obtain sufficient accuracy, the first particle size distribution is determined on at least 1000 primary particles.

To calculate D50 and D99 of the first particle size distribution, a cross-section SEM image of the transition metal oxide precursor particle comprised in the metal oxide product showing clear edges of primary particles is to be referred. The primary particles are selected from the image while avoiding the particles that are truncated by the frame. The area enclosed by the edge of the individual primary particle is used to calculate the equivalent diameter, wherein the equivalent diameter is defined as a diameter of the disk whose area is equal to the area of the particle.

D50 is defined as the equivalent diameter at 50% number distribution of the cumulative particle size distribution. Likewise, D99 is defined as the equivalent diameter at 99% of the cumulative particle size distribution.

Due to the fact that the primary particles are part of larger, secondary particles, the oxide product has a much better flowability compared to an oxide product with only such primary particle. As a consequence, the oxide product according to the invention is less cohesive, which results in a higher bulk density. This has the advantage that the oxide product takes up less space in process equipment, in particular the equipment for performing the abovementioned thermal treatment, so that this process equipment has a higher processing capacity.

Various embodiments according to the present invention are disclosed in the claims as well as in the description. The embodiments and examples recited in the claims and in the description are mutually freely combinable unless otherwise explicitly stated. Throughout the entire specification, if any numerical ranges are provided, the ranges include also the endpoint values unless otherwise explicitly stated.

In a preferred embodiment said first D50 is at most 0.10 μm.

In a preferred embodiment said first D99 is at most 0.30 μm.

In a preferred embodiment said first D50 is at least 0.05 μm, and preferably at least 0.06 μm.

In a preferred embodiment said first D50 is at most 0.09 μm.

In a preferred embodiment said first D99 is at least 0.15 μm, and preferably at least 0.17 μm.

In a preferred embodiment said first D50 is at most 0.27 μm.

As stated above, the metal element contents of the metal oxide product, expressed as x, y, z, a, as defined above, satisfy x+y+z+a=100.0 mol %. This applies to all the embodiments described herein.

In a preferred embodiment x≤99.0 mol %, for example 85.0 mol %≤x≤99.0 mol %.

In a preferred embodiment x≤95.0 mol % and y≥5.0 mol %.

In a preferred embodiment 75.0 mol %≤x≤85.0 mol % and 5.0 mol %≤y≤15.0 mol %; more preferably also 5.0 mol %≤z≤15.0 mol %.

In a preferred embodiment 50.0 mol %≤x≤80.0 mol %, for example x being 55.0, 60.0, 65.0, 70.0, or 75.0 mol %, and 10.0 mol %≤y≤40.0 mol %, for example y being 15.0, 20.0, 25.0, 30.0, or 35.0 mol %.

In a preferred embodiment 20.0 mol %≤x≤45.0 mol %, for example x being 25.0, 30.0, 35.0, or 40.0 mol %.

In a preferred embodiment 0.0 mol %≤y≤5.0 mol %, for example y being 1.0, 2.0, 3.0, or 4.0 mol %.

In a preferred embodiment 20.0 mol %≤x≤25.0 mol % and 1.0 mol %≤y≤3.0 mol %; more preferably also 70.0 mol %≤z≤80.0 mol %.

In a preferred embodiment said one or more oxides of said one or more metals M′ constitute at least 80%, and preferably at least 90%, by weight of said metal oxide product.

In a preferred embodiment said primary particles consist of said one or more oxides of said one or more metals M′.

In a preferred embodiment x<100 mol % and wherein said one or more oxides of said one or more metals M′ are mixed-metal oxides.

In this document, a mixture of single-metal oxides is not considered to be a mixed metal oxide but only oxide compounds containing cations of two or more different metal elements are considered to be mixed metal oxide.

Alternatively, a mixed metal oxide may be defined as a metal oxide in which the metal elements are present in a mixed state at an atomic level.

Alternatively, a mixed metal oxide may be defined as a metal oxide in which each particle of the metal oxide contains all of the metal elements that are present in the metal oxide.

A mixed solution of salts means a solution in which salts of different metal elements are present in the same solvent, irrespective of whether an explicit mixing step has taken place.

In a preferred embodiment said metal oxide product has a second particle size distribution as determined by laser diffraction particle size analysis, wherein said second particle size distribution has a second D50, wherein said second D50 is at least 2.0 μm, and preferably at least 3.5 μm.

If this value is respected, it is ensured that the flowability of the metal oxide product is sufficiently good to obtain a high bulk density.

In a preferred embodiment said metal oxide product has a second particle size distribution as determined by laser diffraction particle size analysis, wherein said second particle size distribution has a second D50, wherein said second D50 is at most 20 μm, and preferably at most 15 μm, and more preferably at most at most 12.5 μm.

This ensures sufficiently good lithiation in the subsequent thermal treatment, which might otherwise be a problem due to long diffusion distances for Li.

For completeness it is noted that D50 is defined as the equivalent diameter at 50% of the second particle size distribution when expressed as a cumulative volumetric particle size distribution. Likewise, D99 is defined as the equivalent diameter at 99% of that second particle size distribution.

In a preferred embodiment said secondary particles are spherical. This additionally helps to obtain a good flowability.

The invention further concerns a method for manufacturing a positive electrode active material for lithium-ion rechargeable batteries, wherein a metal oxide product according to the invention is used as a source of said one or more metals M′ in said positive electrode active material.

Preferably, in said method, the metal oxide product is mixed with a source of Li and the mixture is subjected to a thermal treatment at 500° C. or higher.

The invention further concerns the use of a metal oxide product according to the invention in the manufacture of a positive electrode active material for lithium-ion rechargeable batteries.

### BRIEF DESCRIPTION OF THE FIGURES

FIG. 1a. CS-SEM image of EX1

FIG. 1b. CS-SEM image of CEX1

FIG. 1c. CS-SEM image of EX4

FIG. 1d. CS-SEM image of EX5

### DETAILED DESCRIPTION

In the following detailed description preferred embodiments are described so as to enable the practice of the invention. Although the invention is described with reference to these specific preferred embodiments, it will be understood that the invention is not limited to these preferred embodiments. The invention includes numerous alternatives, modifications and equivalents that are apparent from consideration of the following detailed description and accompanying drawings.

### A) ICP Analysis

The amount of metal elements, e.g. Ni, Mn, and Co, in the precursor, i.e. the metal oxide product, is measured with the Inductively Coupled Plasma (ICP) method by using an Agillent ICP 720-ES (Agilent Technologies). 2 grams of powder sample is dissolved into 10 mL of high purity hydrochloric acid (at least 37 wt. % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 mL volumetric flask for the 2nd dilution, where the volumetric flask is filled with internal standard and 10% hydrochloric acid up to the 250 ml mark and then homogenized. Finally, this 50 mL solution is used for ICP measurement.

### B) Particle Size

### B1) Secondary Particle Size Analysis

The particle size distribution (PSD) of the transition metal oxide precursor powder, i.e. the metal oxide product, is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring is applied, and an appropriate surfactant is introduced. Median size, or D50, is defined as the particle size at 50% of the cumulative volume % distributions obtained from the Malvern Mastersizer 3000 with Hydro MV measurements. Likewise, D99 of this particle size distribution is defined as the equivalent diameter at 99% of this cumulative particle size distribution.

This particle size distribution is also referred to in this document as the second particle size distribution.

### B2) Primary Particle Size Analysis

The diameter of primary particle is calculated by using MountainsLab® Expert Version 8.0.9286 (Digital Surf) according to the following steps:

Step 1) Perform CS-SEM (Cross-section Scanning Electron Microscopy) analysis: Cross-sections of transition metal oxide precursor as described herein are prepared by an ion beam cross-section polisher (CP) instrument JEOL (IB-0920CP). The instrument uses argon gas as beam source. To prepare the specimen, a small amount of a transition metal oxide precursor powder is mixed with a resin and hardener, then the mixture is heated for 10 minutes on a hot plate. After heating, it is placed into the ion beam instrument for cutting and the settings are adjusted in a standard procedure, with a voltage of 6.5 kV for a 3 hours duration.

The morphology of positive electrode active materials is analyzed by a Scanning Electron Microscopy (SEM) technique. The measurement is performed with a JEOL JSM 7100F under a high vacuum environment of 9.6×10⁻⁵ Pa at 25° C.

Step 2) Load the file containing cross-sectional SEM image of transition metal oxide precursor with 10,000 times magnification obtained from Step 1). The image should have suitable contrast and brightness so that the edges of the primary particles are clearly observed.

Step 3) Set scale according to the SEM magnification.

Step 4) Extract area at the center part of the secondary particle by setting position left and bottom at 25% and right and top at 75%.

Step 5) Set Edge Detection in the Particle Analysis then set no filter at Pre-processing and Height pruning <5%.

Step 6) Refine detection by selecting Remove particles on edges, thereby removing particles truncated by frame line.

Step 7) Obtain primary particle size by selecting Statistical result and selecting equivalent diameter parameter.

When the particle appears porous in the CS-SEM image, pores with equivalent diameter bigger than 0.40 μm is removed from the measurement to resolve the machine limitation in which the pores are calculated as particle.

A cumulative primary particle size distribution of the primary particles is now obtained based on the individual diameters of at least 1000 primary particles from at least one secondary particle.

This particle size distribution is also referred to in this document as the first particle size distribution.

D50 of this particle size distribution is defined as the equivalent diameter at 50% of this cumulative particle size distribution. Likewise, D99 of this particle size distribution is defined as the equivalent diameter at 99% of this cumulative particle size distribution.

### C) Coin Cell Testing

### C1) Coin Cell Preparation

For the preparation of a positive electrode, a slurry that contains a positive electrode active material powder, a conductor (Super P, Timcal), a binder (KF #9305, Kureha) —with a formulation of 90:5:5 by weight—, and a solvent (NMP, Mitsubishi), is prepared by using a high-speed homogenizer. The homogenized slurry is spread on one side of an aluminum foil using a doctor blade coater with a 230 μm gap. The slurry-coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between the positive electrode and a piece of lithium foil used as a negative electrode. 1M LiPF₆ in EC:DMC (1:2) is used as electrolyte and is dropped between separator and electrodes. Then, the coin cell is completely sealed to prevent leakage of the electrolyte.

### C2) Testing Method

Each coin cell is cycled at 25° C. using a Toscat-3100 computer-controlled galvanostatic cycling stations (from Toyo). The coin cell testing schedule used to evaluate samples is detailed in the Table 1. The definition of a 1C current is 160 mA/g.

The first discharge capacity DQ1 is measured in constant current mode (CC). The capacity fading rate (QF) is obtained according to below equation.

$$QF ( \% / 100 cycle ) = ( 1 - \frac{D {Q}_{35}}{D {Q}_{8}} ) \times \frac{1}{27} \times 10000$$

wherein DQ8 is the discharge capacity at the 8^{th} cycle and DQ35 is the discharge capacity at the 35^{th} cycle.

TABLE 1
Coin cell testing schedule

| | Charge | | | | | Discharge | | | |
|---|---|---|---|---|---|---|---|---|---|
| | | | | | V/Li | | | | V/Li |
| | C | End | | Rest | metal | C | End | Rest | metal |
| Cycle | Rate | current | | (min) | (V) | Rate | current | (min) | (V) |
| 1 | 0.10 | — | | 30 | 4.3 | 0.10 | — | 30 | 3.0 |
| 2 | 0.25 | 0.05 | C | 10 | 4.3 | 0.20 | — | 10 | 3.0 |
| 3 | 0.25 | 0.05 | C | 10 | 4.3 | 0.50 | — | 10 | 3.0 |
| 4 | 0.25 | 0.05 | C | 10 | 4.3 | 1.00 | — | 10 | 3.0 |
| 5 | 0.25 | 0.05 | C | 10 | 4.3 | 2.00 | — | 10 | 3.0 |
| 6 | 0.25 | 0.05 | C | 10 | 4.3 | 3.00 | — | 10 | 3.0 |
| 7 | 0.25 | 0.1 | C | 10 | 4.5 | 0.10 | — | 10 | 3.0 |
| 8 | 0.25 | 0.1 | C | 10 | 4.5 | 1.00 | — | 10 | 3.0 |
| 9-33 | 0.50 | 0.1 | C | 10 | 4.5 | 1.00 | — | 10 | 3.0 |
| 34 | 0.25 | 0.1 | C | 10 | 4.5 | 0.10 | — | 10 | 3.0 |
| 35 | 0.25 | 0.1 | C | 10 | 4.5 | 1.00 | — | 10 | 3.0 |

### D) Bulk Density

The bulk density of the precursor material powder, i.e. the metal oxide product, is determined by measuring the mass of the powder flowed into the graduated cylinder with a specific volume. The precursor bulk density is calculated according to:

$$powder bulk density = \frac{mass of powder inside graduated cylinder ( gram )}{v olume of graduated cylinder ( {cm}^{3} )}$$

The invention is further illustrated by the following (non-limitative) examples:

### Comparative Example 1

CEX1 was obtained through a spray pyrolysis and spray drying process running as follows:
1) Feed solution preparation: a feed solution comprising NiCl₂, MnCl₂, and CoCl₂ solution in water with total concentration of 110 gram/L having Ni, Mn, and Co in a ratio Ni:Mn:Co of 0.6:0.2:0.2 was prepared.
2) Spray pyrolysis: the feed solution prepared from Step 1) was sprayed into a heated chamber at 650° C. so as to oxidize the salt and form mix metal oxide powder. Chamber volume was approximately 8.8 m³ and feed rate was 30 L/hour.
3) Washing: the mix metal oxide powder from Step 2) was washed with water (25 wt. % solid content) to remove impurities such as CI residue.
4) Slurry formulation: Slurry was prepared by mixing washed powder from Step 3) with dispersant (Dolapix CA, Zschimmer & Schwarz, DE) so as to have a 70 wt % solid content and 2 wt % dispersant in water.
5) Wet bead mill: Slurry prepared in step 4) was wet bead milled in water with specific milling energy of 200 kWh/T. Milling media was Y stabilized ZrO₂ bead (YSZ) with 1 mm diameter. The milled powder particle median size as obtained by laser diffraction method was 0.71 μm.
6) Spray drying: Milled slurry prepared in Step 5) was spray dried by two fluid nozzles with inlet temperature of 170° C. and outlet temperature of 100° C.
7) Heating: the spray dried powder obtained from Step 6) was heated in a furnace at 500° C. for 5 h under oxygen atmosphere. The result of this step was a heated precursor powder labelled as CEX1.

CEX1 comprises of secondary particles having a plurality of primary particles wherein the primary particle size (first particle size distribution) D50 was 0.11 μm and D99 was 0.35 μm as determined according to the method described in the primary particle size analysis. Secondary particle (second particle size distribution) D50 was 15.1 μm and bulk density was 0.8 gr/cm³.

CEX1 is not according to the present invention.

### Example 1

EX1 was prepared according to the same method as CEX1 except that in Step 5) the wet bead mill specific milling energy was 1300 kWh/T. The milled powder particle median size in the slurry after step 5, as obtained by laser diffraction method was 0.28 μm.

EX1 consists of secondary particles having a plurality of primary particles wherein the primary particle size (first particle size distribution) D50 was 0.08 μm and D99 was 0.20 μm as determined according to the method described in the primary particle size analysis. Secondary particle (second particle size distribution) D50 was 12.6 μm and bulk density was 1.5 gr/cm³.

### Comparative Example 2

CEX2.1 was obtained through a solid-state reaction between a lithium source and a transition metal-based precursor running as follows:
1) Mixing: the precursor powder CEX1 and LiOH as a lithium source were homogenously mix with a lithium to metal Me (Li/Me) ratio of 1.05 in an industrial blending equipment to obtain a mixture (Me=Ni, Mn, Co).
2) Heating: the mixture from Step 1) was heated at 840° C. for 15 hours under an oxygen atmosphere. The heated powder was crushed, classified, and sieved so as to obtain a lithiated product, i.e. a positive electrode active material powder.

CEX2.2 was prepared according to the same method as CEX2.1 except that the Li/Me ratio in Step 1) was 1.03 and heating temperature in Step 2) was 860° C.

CEX2.1 and CEX2.2 are not according to the present invention.

### Example 2

EX2.1, which is according to the present invention, was prepared according to the same procedure as CEX2.1, except that precursor powder used in Step 1) was EX1 instead of CEX1.

EX2.2, which is according to the present invention, was prepared according to the same procedure as CEX2.2, except that precursor powder used in Step 1) was EX1 instead of CEX1.

### Example 3

EX3 was prepared according to the same method as EX1 except that the feed solution in the step 1) only comprised NiCl₂. EX3 is a NiO precursor having bulk density of 1.5 g/cm³.

### Example 4

EX4 was obtained through a spray pyrolysis and spray drying process running as follows:
1) Feed solution preparation: a feed solution comprising NiCl₂, MnCl₂, and CoCl₂ solution in water with total concentration of 110 gram/L having Ni, Mn, and Co in a ratio Ni:Mn:Co of 0.8:0.1:0.1 was prepared.
2) Spray pyrolysis: the feed solution prepared from Step 1) was sprayed into a heated chamber at 680° C. so as to oxidize the salt and form mix metal oxide powder. Chamber volume was approximately 8.8 m³ and feed rate was 30 L/hour.
3) Washing: the mix metal oxide powder from Step 2) was washed with water (25 wt. % solid content) to remove impurities such as CI residue.
4) Slurry formulation: Slurry was prepared by mixing washed powder from Step 3) with dispersant (Dolapix CA, Zschimmer & Schwarz, DE) so as to have a 60 wt % solid content and 2 wt % dispersant in water.
5) Wet bead mill: Slurry prepared in step 4) was wet bead milled in water with specific milling energy of 1500 kWh/T. Milling media was Y stabilized ZrO₂ bead (YSZ) with 0.3 mm diameter. The milled powder particle median size as obtained by laser diffraction method was 0.25 μm.
6) Spray drying: Milled slurry prepared in Step 5) was being spray dried by rotary atomizer with inlet temperature of 250° C. and outlet temperature of 100° C.
7) Heating: the spray dried powder obtained from Step 6) was heated in a furnace at 500° C. for 5 h under oxygen atmosphere. The result of this step was a heated precursor powder labelled as EX4.

EX4 comprises of secondary particles having a plurality of primary particles wherein the primary particle size (first particle size distribution) D50 was 0.05 μm and D99 was 0.28 μm as determined according to the method described in the primary particle size analysis. Secondary particle (second particle size distribution) D50 was 12.4 μm and bulk density was 1.4 gr/cm³.

### Example 5

EX5 was obtained through a spray pyrolysis and spray drying process running as follows:
1) Feed solution preparation: a feed solution comprising NiCl₂, MnCl₂, and CoCl₂ solution in water with total concentration of 110 gram/L having Ni, Mn, and Co in a ratio Ni:Mn:Co of 0.22:0.76:0.02 was prepared.
2) Spray pyrolysis: the feed solution prepared from Step 1) was sprayed into a heated chamber at 600° C. so as to oxidize the salt and form mix metal oxide powder. Chamber volume was approximately 8.8 m³ and feed rate was 30 L/hour.
3) Washing: the mix metal oxide powder from Step 2) was washed with water (25 wt. % solid content) to remove impurities such as CI residue.
4) Slurry formulation: Slurry was prepared by mixing washed powder from Step 3) with dispersant (Dolapix CA, Zschimmer & Schwarz, DE) so as to have a 67 wt % solid content and 2 wt % dispersant in water.
5) Wet bead mill: Slurry prepared in step 4) was wet bead milled in water with specific milling energy of 2130 kWh/T. Milling media was Y stabilized ZrO₂ bead (YSZ) with 0.3 mm diameter. The milled powder particle median size as obtained by laser diffraction method was 0.22 μm.
6) Spray drying: Milled slurry prepared in Step 5) was spray dried by high pressure nozzles with inlet temperature of 250° C. and outlet temperature of 100° C.
7) Heating: the spray dried powder obtained from Step 6) was heated in a furnace at 500° C. for 5 h under oxygen atmosphere. The result of this step was a heated precursor powder labelled as EX5.

EX5 comprises of secondary particles having a plurality of primary particles wherein the primary particle size (first particle size distribution) D50 was 0.067 μm and D99 was 0.159 μm as determined according to the method described in the primary particle size analysis. Secondary particle (second particle size distribution) D50 was 7.6 μm and bulk density was 0.8 gr/cm³.

TABLE 2
Summary of the preparation condition and the corresponding electrochemical
properties of examples and comparative examples.

| | Precursor | | | | | | |
|---|---|---|---|---|---|---|---|
| | | First particle | | Lithiation condition | | Electrochemical property | |
| | | size distribution | | | Temperature | DQ1 | QF (%/100 |
| ID | ID | D50 (μm) | D99 (μm) | Li/Me | (° C.) | (mAh/g) | cycles) |
| CEX2.1 | CEX1 | 0.11 | 0.35 | 1.05 | 840 | 171.5 | 17.8 |
| CEX2.2 | | | | 1.03 | 860 | 172.8 | 19.8 |
| EX2.1 | EX1 | 0.08 | 0.20 | 1.05 | 840 | 176.4 | 16.9 |
| EX2.2 | | | | 1.03 | 860 | 177.4 | 12.2 |

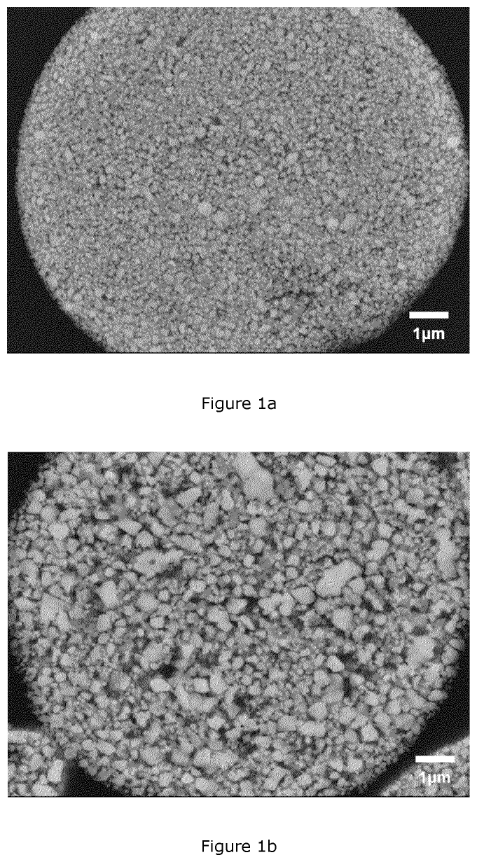

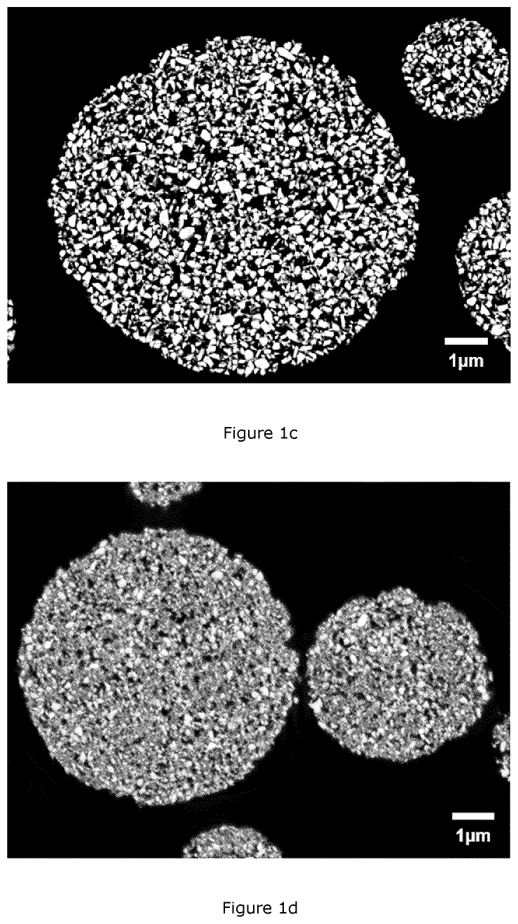

Table 2 summarizes the first particle size distribution of precursor CEX1 and EX1, as well as the preparation condition and the electrochemical properties of CEX2.1, CEX2.2, EX2.1, and EX2.2. The average first particle size distribution D50 of EX1 is 0.08 μm, smaller than the average first particle size distribution of CEX1 which is 0.11 μm. The primary particle SEM images of EX1 and CEX1 are shown in FIGS. 1b and 1a, respectively.

Positive electrode active material EX2.1 and EX2.2 which are manufactured from precursor EX1, show higher DQ1 and lower QF in comparison with positive electrode active material CEX2.1 and CEX2.2 which are manufactured from precursor CEX1. It shows that the precursor with first particle size distribution D50 of at least 0.05 μm and at most 0.10 μm and D99 of at least 0.15 μm and at most 0.30 μm is suitable to achieve the object of the present invention, which is to provide a positive electrode active material having an improved first discharge capacity of at least 174 mAh/g and capacity fading of at most 17%/100 cycles.

1-14. (canceled)

15. A metal oxide product for manufacturing a positive electrode active material for lithium-ion rechargeable batteries, wherein the metal oxide product comprises one or more oxides of one or more metals M′, wherein M′ comprises:
Ni in a content x between 20.0 mol % and 100.0 mol %, relative to M′,
Co in a content y between 0.0 mol % and 60.0 mol %, relative to M′,
Mn in a content z between 0.0 mol % and 80.0 mol %, relative to M′,
D in a content a between 0.0 mol % and 5.0 mol %, relative to the total atomic content of M′, wherein D comprises at least one element of the group consisting of: Al, B, Ba, Ca, Cr, Fe, Mg, Mo, Nb, S, Si, Sr, Ti, Y, V, W, Zn, and Zr,
wherein x, y, z, and a are measured by ICP, wherein x+y+z+a=100.0 mol %,
wherein the metal oxide product comprises secondary particles each comprising a plurality of primary particles,
wherein said primary particles have a first particle size distribution,
wherein said first particle size distribution has a first D50 of at most 0.10 μm and a first D99 of at most 0.30 μm.

16. The metal oxide product according to claim 15, wherein said first D50 is at least 0.05 μm and said first D99 is at least 0.15 μm.

17. The metal oxide product according to claim 15, wherein said first D50 is at least 0.06 μm and at most 0.09 μm.

18. The metal oxide product according to claim 15, wherein said first D99 is at least 0.17 μm and at most 0.28 μm.

19. The metal oxide product according to claim 15, wherein x≤95.0 mol % and y≥5.0 mol %.

20. The metal oxide product according to claim 15, wherein 50.0 mol %≤x≤80.0 mol % and 10.0 mol %≤y≤40.0 mol %.

21. The metal oxide product according to claim 15, wherein said one or more oxides of said one or more metals M′ constitute at least 80% by weight of said metal oxide product.

22. The metal oxide product according to claim 15, wherein said primary particles consist of said one or more oxides of said one or more metals M′.

23. The metal oxide product according to claim 15, wherein x<100 mol % and wherein said one or more oxides of said one or more metals M′ are mixed metal oxides.

24. The metal oxide product according to claim 15, wherein said metal oxide product has a second particle size distribution as determined by laser diffraction particle size analysis, wherein said second particle size distribution has a second D50, wherein said second D50 is at least 2 μm.

25. The metal oxide product according to claim 15, wherein said metal oxide product has a second particle size distribution as determined by laser diffraction particle size analysis, wherein said second particle size distribution has a second D50, wherein said second D50 is at most 15 μm.

26. The metal oxide product according to claim 15, wherein said secondary particles are spherical.

27. A method for manufacturing a positive electrode active material for lithium-ion rechargeable batteries, wherein the metal oxide product according to claim 15 is used as a source of said one or more metals M′.

28. The method according to claim 27, wherein said metal oxide product is mixed with a source of Li and subjected to a thermal treatment at 500° C. or higher.
